(19) United States
(12) Patent Application Publication
(10) Pub. No.: US 2007/0007905 A1
(43) Pub. Date: Jan. 11, 2007

(54) Low frequency triggered electronic ballast

(75) Inventor: Sing Chu, Taipei City (TW)

Correspondence Address: BACON & THOMAS, PLLC, 625 SLATERS LANE, FOURTH FLOOR, ALEXANDRIA, VA, 22314, US

(73) Assignee: DJ Auto Components Corp., Tao-yuan Hsien (TW)

(21) Appl. No.: 11/403,821

(22) Filed: Apr. 14, 2006

(30) Foreign Application Priority Data
Jul. 11, 2005 (TW) 094211735

(51) Int. Cl. F02P 3/08

(52) U.S. Cl. 315/209 CD

(57) ABSTRACT

An electronic ballast, The ballast use voltage controlling the energy storage capacitor, Furthermore, the electronic ballast continuously detects the current value and the voltage value of the HID lamp, change the pulse-width signal according to the detection result to control the HID lamp within a stable working current.

### BACKGROUND OF THE INVENTION

1. Field of the Invention

The present invention relates to electronic ballast, and more particularly, to low frequency triggered electronic ballast.

2. Description of the Related Art

Generally, under normal conditions, the two electrodes of a high intensity discharge (HID) lamp do not conduct with each other; in order to turn on the HID lamp, a high voltage pulse must first be applied, which is in the range of 20˜25K volts for stable ignition. Electronic ballast is used to provide not just an ignition pulse, but also a low frequency AC voltage about 80-120 volts to sustain a stable arc inside the lamp. The electronic ballast also controls the current to protect the lamp and other components.

In the conventional system as shown in FIG. 1, a high frequency DC-DC converter in the front of ballast using a pulse-width modulation (PWM) signal to control a transformer 190 boosts the 12V car battery 191 up to the 80-300V DC voltage. The high frequency square wave across the secondary winding of the transformer 190 passes through a voltage doubling rectifying circuit 192, which comprises C1, D1, D2, and C2, to generate a high DC voltage to charge an energy storage capacitor 194. When the power of the lamp is initially turned on, since the transformer 190 is nearly in a no-load state, the charged voltage on the energy storage capacitor will quickly exceed 600 volts. A gas discharge tube 193, with a breakdown voltage of about 600 volts, is in a parallel with the energy storage capacitor 194, and so when the voltage reaches the breakdown voltage of the gas discharge tube 193, the electrical energy stored in the energy storage capacitor 194 can pass through a primary winding N1 of a high voltage transformer 195 to generate a huge transient current pulse. According to the principle of mutual inductance theory, the secondary winding N2, having a high turn ratio, of the high voltage transformer 195 can generate a high voltage pulse of about 26 KV to ignite an HID lamp 196. However, in the conventional system, an about 600V high voltage is existed in the lamp driver loop. Therefore, the high voltage rating components are necessary. That makes the ballast system to deteriorate the efficiency and to increase the manufacturing cost.

### SUMMARY OF THE INVENTION

The present invention provides a low frequency triggered electronic ballast, which is electrically connected to a high intensity discharge (HID) lamp and a power supply. The electronic ballast comprises: a power supply controller electrically connected to the power supply, to control the power supply to supply electric power to the electronic ballast; a DC-DC circuit electrically connected to the power supply. The DC-DC circuit comprising a first transformer and a low voltage switching element; a microprocessor electrically connected to the power supply controller and the low voltage switching element in the DC-DC circuit respectively; wherein when the power supply controller turns on the power, the microprocessor outputs a low frequency pulse-width modulated (PWM) signal to the low voltage switching element then the first transformer of the DC-DC circuit outputs a medium-level DC voltage; a full-bridge circuit electrically connected to the DC-DC circuit and the microprocessor respectively, the full-bridge circuit inverting the medium-level DC voltage provided by the DC-DC circuit to a low frequency AC voltage; and an ignition circuit comprising circuit is electrically connected to the full-bridge circuit, the second transformer is electrically connected to the HID lamp, the low frequency voltage doubling rectifying circuit receives the low frequency square voltage pulse provided by the full-bridge circuit and outputs a high DC voltage to charge the energy storage capacitor; wherein when the energy storage capacitor is charged to exceed the breakdown voltage of the gas discharge tube, the gas discharge tube turns on and the high voltage induced across the secondary winding of the second transformer breaks the HID lamp over.

The present invention can use a low frequency square pulse output by the full-bridge circuit to produce a high DC voltage by the voltage doubling rectifying circuit to charge the energy storage capacitor, which results in the use of the lower voltage rating power devices for the HID lamp ballast system compared with conventional system and reduces the manufacturing costs.

The electronic ballast of the present invention further comprises a low frequency driving controller electrically connected between the microprocessor and the full-bridge circuit, the low frequency driving controller controlling the full-bridge circuit to output a low frequency square voltage pulse at a specific frequency. Therefore, the low frequency driving controller may control the full-bridge circuit to output a medium-level voltage square pulse with a stable low frequency for increasing the stability of the system.

Furthermore, the microprocessor detects at least one value of a group of: the voltage value of the power supply, the current value of the low voltage switching element, the voltage value of the HID lamp, or the current value of the HID lamp; wherein when at least one value being detected is increased, the microprocessor correspondingly decreases the pulse-width of the PWM signal. Therefore, the microprocessor may change the pulse-width to avoid damaging the low voltage switching element or other related devices according to the detected voltage value or current value of the HID lamp.

Other objects, advantages, and novel features of the invention will become more apparent from the following detailed description when taken in conjunction with the accompanying drawings.

### BRIEF DESCRIPTION OF THE DRAWINGS

FIG. 1 is a functional block drawing of the conventional electronic ballast.

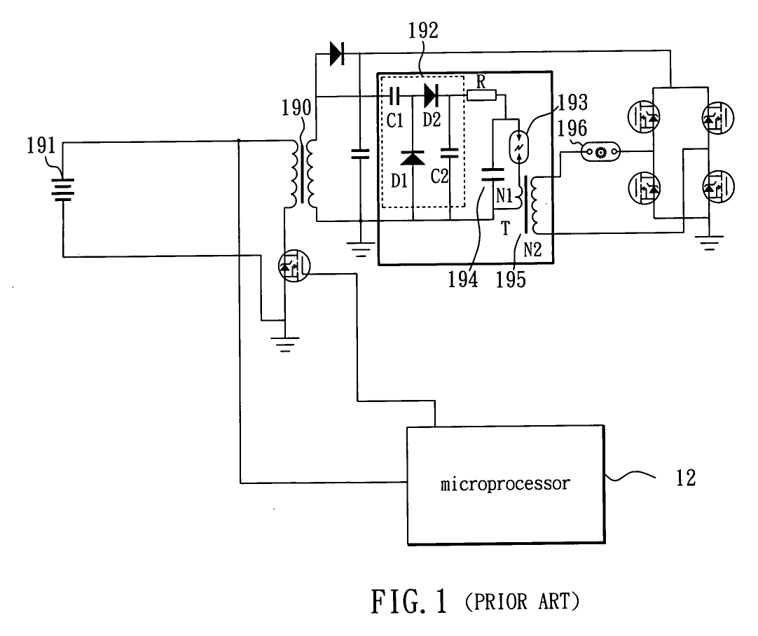

FIG. 2 is a functional block drawing of the present invention.

FIG. 3 is the setting for the operation of the present invention.

FIG.4 is a schematic drawing of a PWM signal used by the present invention.

### DETAILED DESCRIPTION OF THE PREFERRED EMBODIMENT

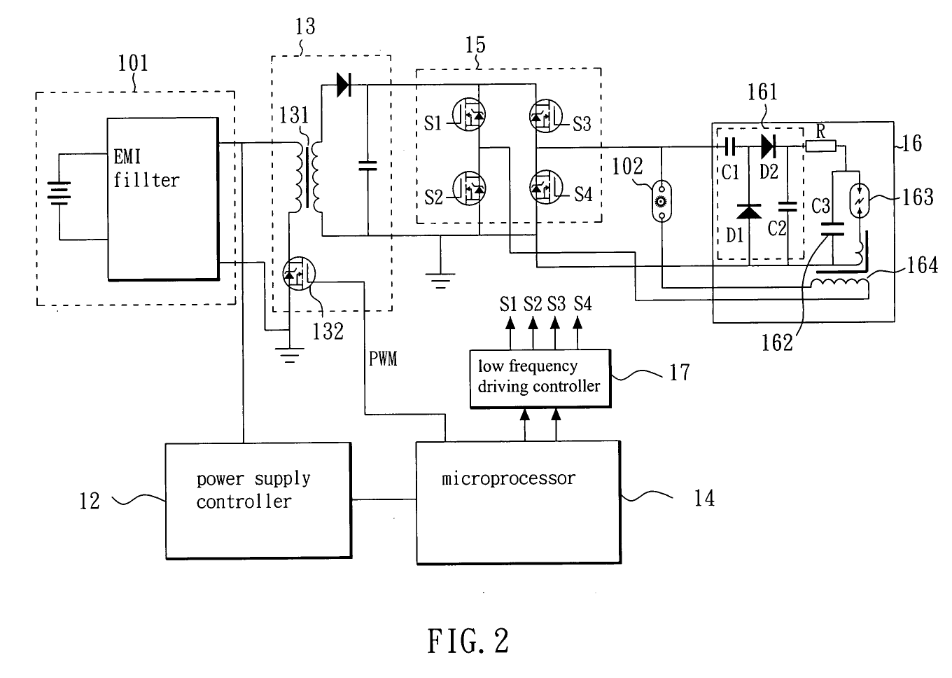

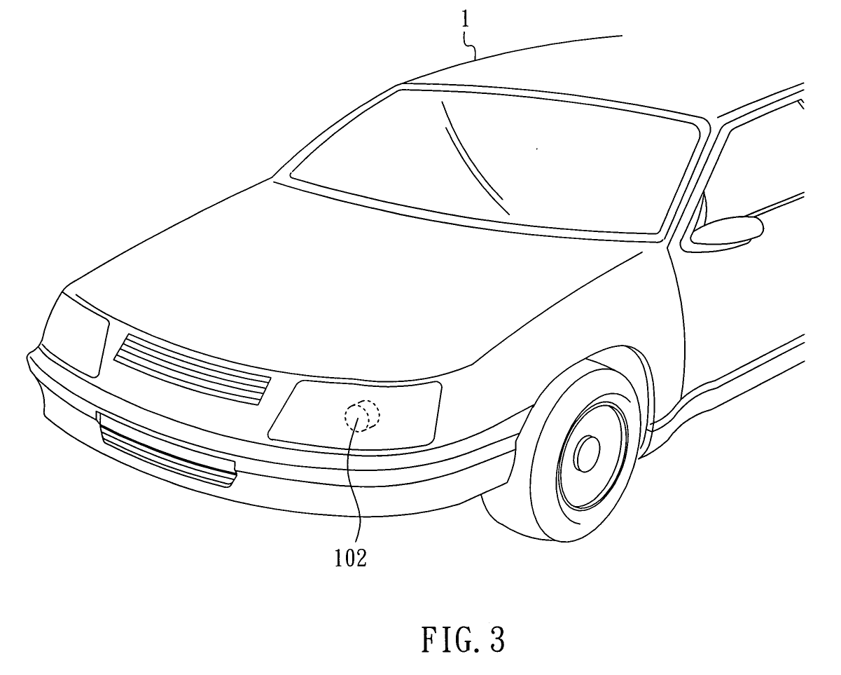

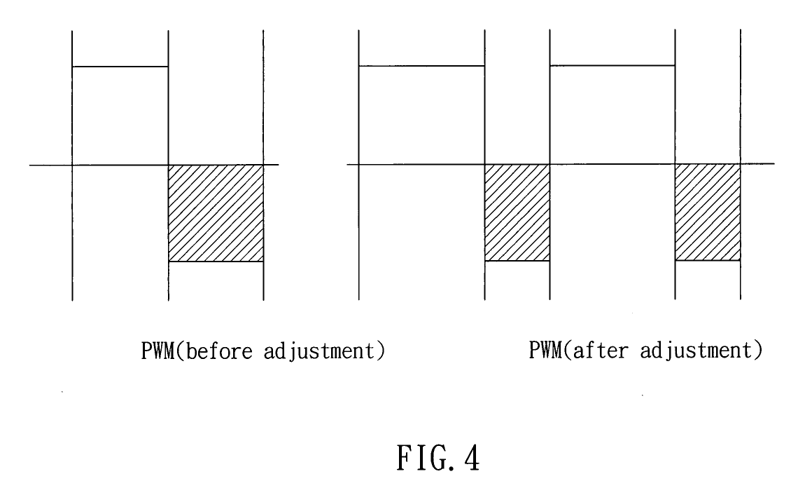

Please refer to FIG. 2 and FIG. 3. FIG. 2 is a functional block drawing of an embodiment according to the present invention. FIG. 3 shows an embodiment according to the setting for the operation of the present invention. In this embodiment, electronic ballast 10 is electrically connected to an HID lamp 102 of a vehicle 1 and a power supply 101. In this embodiment, the electronic ballast 10 is a part of a vehicle headlight assembly, and comprises: a power supply controller 12, a DC-DC circuit 13, a microprocessor 14, a full-bridge driving circuit 15, and an ignition circuit 16. In this embodiment, the power supply controller 12 is preferably an on-off switch or some other equivalent device, such as a button. The power supply controller 12 is electrically connected to the power supply 101 and is used to control the power supply to supply electric power to the electronic ballast. In this invention, the power supply 101 is a 12 voltage power supply and comprises an electromagnetic interference (EMI) filter 11 electrically connected to the power supply 101 to eliminate or decrease the electromagnetic interference in the electric power. The DC-DC circuit 13 is electrically connected to the power supply 101, and the DC-DC circuit 13 further comprises a first transformer 131 and a low voltage switching element 132. In this embodiment, the low voltage switching element 132 is an N-Channel MOSFET. The microprocessor 14 may be an 8-bit processor, which is electrically connected to the power supply controller 12 and the low voltage switching element 132 of the DC-DC circuit 13 respectively. When the power supply controller 12 turns on the power, microprocessor the microprocessor 14 outputs a high frequency pulse-width modulated (PWM) signal to turn on and turn off the low voltage switching element 132. Therefore, the DC-DC circuit 13 boosts the 12V voltage of the car battery to a medium-level DC voltage of about 80˜300 volts, which is the input voltage of the full-bridge driver circuit 15. In this invention, the microprocessor 14 further detects at least one value of a group of: a voltage value of the power supply 101, a current value of the low voltage switching element 132, a voltage value of the HID lamp 102, and a current value of the HID lamp 102. As shown in FIG. 4, when the value being detected is increased, the microprocessor decreases the pulse-width of the PWM signal so that the microprocessor 14 can precisely control the voltage and current of the HID lamp 102.

In this embodiment, the full-bridge circuit 15 may be electrically connected to the DC-DC circuit 13 and the microprocessor 14 respectively. The input of the full-bridge circuit 15 is the medium-level DC voltage output by the DC-DC circuit 13 and is inverted by the full-bridge circuit 15 to an AC square wave pulse with a low frequency of about 400 Hz. In this embodiment, the electronic ballast 10 further comprises a low frequency driving controller 17, which is electrically connected, between the microprocessor 14 and the full-bridge circuit 15. The full-bridge circuit 15 is composed of 4 N-Channel MOSFETs S1, S2, S3, and S4. The low frequency driving controller 17 controls the 4 MOSFETs to turn on and turn off, that makes the full-bridge circuit 15 output a low frequency AC voltage on the two electrodes of the HID lamp.

The ignition circuit 16 comprises a low frequency voltage doubling rectifying circuit 161, an energy storage capacitor 162, a gas discharge tube 163, and a second transformer 164. The low frequency voltage doubling rectifying circuit 161 is electrically connected to the full-bridge circuit 15, and the second transformer 164 is electrically connected to the HID lamp 102. The low frequency voltage doubling rectifying circuit 161 receives the low frequency square voltage pulse provided by the full-bridge circuit 15 and outputs a high DC voltage, which charges the energy storage capacitor 162. When the energy storage capacitor 162 is charged to exceed the breakdown voltage of the gas discharge tube 163, the gas discharge tube 163 turns on and a large current is quickly flowed through the primary winding of the second transformer 164, causing a high voltage about 26K volts to be induced across the secondary winding of the second transformer 164, which has a high turn ratio. Since the secondary winding of the second transformer 164 connects between the HID lamp 102 and the full-bridge circuit 15, when the secondary winding generates a high voltage pulse about 26K volts, the metals and gases inside the HID lamp 102 are ionized causing the HID lamp 102 to form an arc discharge and emit the light. To sustain a stable discharge arc inside the HID tube, a 400 Hz low frequency square voltage pulse output by the full-bridge circuit 15 is provided between the two electrodes of the HID lamp 102. Furthermore, since the microprocessor 14 continuously detects the current value and the voltage value of the HID lamp 102, the microprocessor 14 may change the pulse-width of the PWM signal according to the detection result to control the HID lamp 102 within a stable working current.

As indicated in the above, the present invention use the medium-level low frequency AC voltage provided by the full-bridge circuit to produce a high DC voltage, by the voltage doubling rectifying circuit, for the charge the energy storage capacitor, that simplifies the circuit design, decreases wasted power, increases the working efficiency of the circuit and reduces manufacturing costs. The low frequency driving controller drives the full-bridge circuit to output a low frequency mid-level voltage pulse to enable the HID lamp 102 to generate a stable discharge arc. The microprocessor may change the pulse-width of the PWM signal to avoid the damaging of the power devices in the ballast according to the detected voltage value or current value of the HID lamp 102.

Although the present invention has been explained in relation to its preferred embodiment, it is to be understood that many other possible modifications and variations can be made without departing from the scope of the invention as hereinafter claimed.

What is claimed is:

1. A low frequency triggered electronic ballast electrically connected to a high intensity discharge (HID) lamp and a power supply, the electronic ballast comprising:
a power supply controller electrically connected to the power supply to control the power supply to supply electric power to the electronic ballast;
a DC-DC circuit electrically connected to the power supply and comprising a first transformer and a low voltage switching element;
a microprocessor electrically connected to the power supply controller and the low voltage switching element in the DC-DC circuit respectively; wherein when the power supply controller turns on the power, the microprocessor outputs a low frequency pulse-width modulated signal to the low voltage switching element, then the first transformer of the DC-DC circuit outputs a medium-level DC voltage;
a full-bridge circuit electrically connected to the DC-DC circuit and the microprocessor respectively, the full-bridge circuit inverting the medium-level DC voltage provided by the DC-DC circuit to a low frequency AC voltage; and
an ignition circuit comprising circuit is electrically connected to the full-bridge circuit, the second transformer is electrically connected to the HID lamp, the low frequency voltage doubling rectifying circuit receives the low frequency square voltage pulse provided by the full-bridge circuit and outputs a high DC voltage to charge the energy storage capacitor; wherein when the energy storage capacitor is charged to exceed the breakdown voltage of the gas discharge tube, the gas discharge tube turns on and the high voltage induced across the secondary winding of the second transformer breaks the HID lamp over.

2. The electronic ballast as claimed in claim 1 further comprising an electromagnetic interference (EMI) filter electrically connected to the power supply for avoiding the electromagnetic interference.

3. The electronic ballast as claimed in claim 1 further comprising a low frequency driving controller electrically connected between the microprocessor and the full-bridge circuit, the low frequency driving controller controlling the full-bridge circuit to output a low frequency square voltage pulse at the specific frequency.

4. The electronic ballast as claimed in claim 1, wherein the microprocessor detects at least one value of a group of: a voltage value of the power supply, a current value of the low voltage switching element, a voltage value of the HID lamp, and a current value of the HID lamp; wherein when the at least one value being detected is increased, the microprocessor correspondingly decreases the pulse-width of the PWM signal.

5. The electronic ballast as claimed in claim 1, wherein the specific frequency of the low frequency square voltage pulse output by the full-bridge circuit is 400 Hz.

6. The electronic ballast as claimed in claim 1, wherein the breakdown voltage of the gas discharge tube is 600 volts.

7. The electronic ballast as claimed in claim 1, wherein the low-level voltage switching element comprises an N-Channel MOSFET.

8. The electronic ballast as claimed in claim 1, wherein the power supply controller comprises an on-off switch.

9. The electronic ballast as claimed in claim 1, wherein the microprocessor is an 8-bit processor.

10. The electronic ballast as claimed in claim 1, wherein the HID lamp is installed in a vehicle headlight assembly.
